(19) United States
(12) Patent Application Publication
(10) Pub. No.: US 2020/0022335 A1
(43) Pub. Date: Jan. 23, 2020

(54) Dog's play partner AI dog

(71) Applicant: Yuan Qing Wu, Richmond (CA)

(72) Inventor: Yuan Qing Wu, Richmond (CA)

(21) Appl. No.: 16/039,319

(22) Filed: Jul. 18, 2018

(51) Int. Cl. A01K 15/02; G05D 1/00; G05D 1/02; G06F 3/16

(52) U.S. Cl. CPC A01K 15/02; G06F 3/167; G05D 1/0221; G05D 1/0088

(57) ABSTRACT

This utility patent publicizes a kind of dog's play partner AI Dog, once Voices/Sounds Controlling Module “hears” any sounds in home or surroundings, it will automatically start,

Round Base Disk loaded with Dog Statue on it is moving around fast in random directions, Dog Statue's head and feet/body and tail, etc, are moving accordingly, Beeping Pads are glittering, the pre-recorded dog's vocal sounds and beeps are playing, this series of actions will induce and stimulate the dog to be chasing and playing with AI Dog, which is still moving around fast in random directions or has just stopped moving. And when the dog jumps or steps on Round Base Disk, paws stepping on Beeping Pad(s), Pad(s) will beep to (further) induce and stimulate the dog to be chasing and playing with AI Dog, which (is still)/has just started—moving around fast in random directions.

AI Dog imitates a dog's behaviour and vocal sounds, along with pre-recorded beeps (including the initial beeping made from Voices/Sounds Controlling Module and the second beeps made from Beeping Pads) and Pads glittering, when it is moving around fast in random directions, it will induce and stimulate the dog to be chasing and play with it (or each other on the advanced model), in this way, it will serve as play partner to the dog alone at home so that the dog can still keep active and healthy, fulfilling every dog owner's desire.

### TECHNICAL FIELD

This utility relates to a kind of dog's play partner AI Dog (basic and advanced models).

### BACKGROUND ART

Nowadays on the market there are dog's toys at the best, which are not good enough to be a dog's play partner like AI Dog, as in this utility patent. Because:

when a dog is home alone (that is dog owner is not home), in order to induce and stimulate the dog to chase and play with the toy, two conditions must be met: first, the toy needs the dog owner to get it moving, for instance, this patented American dog's toy K9 Cruiser (see FIG. 2,—in case the scanned copy of FIG. 2 is unsatisfactory, please Google it out for details—its pictures and what dog owner needs to do to get the dog interested in playing with the toy), dog owner would first need to get it moving (gliding) by kicking it; second, the toy needs the dog owner to keep stepping on it and making it beep. However, these two conditions can't be met, since the dog owner is not home.

Therefore, when a dog is home alone, it would not be able to get induced and stimulated into chasing and playing with its toys, hence it would have nothing to do but sleep.

### SUMMARY OF INVENTION

### Technical Problems

In order to overcome the currently technical problems of dog's toys being unable to automatically,—move (around in random directions) and sound {only by moving (fast) and beeping [accompanied by the glittering as from Beeping Pads (e.g. parts in this patented design) for best effects] can the dog be induced and stimulated to chase and play with dog's toys}, this utility patent provides an AI Dog, which serves as the dog's play partner.

In order to overcome the currently technical problem of that there is no interaction provided between the dog and its owner when he or she is not home, this utility patent provides an AI Dog (advanced model).

In order to overcome the current technical problem there is no easy interaction provided through AI Dog between the dog and its owner when he or she is home, this utility patent provides Voice Commands and their counterparts—Verbal Commands on AI Dog advanced model.

### Solutions to Problems

The technical scheme this utility patent utilizes in solving all the technical problems is: a kind of AI Dog, it through Round Base Disk {same operational principles as the round disk [see FIG. 3 (top), FIG. 4 (bottom); as the latter] of iRobot Roomba (pre-980 models): diameter 1 foot (same as the latter), underneath the Round Base Disk are there three wheels, the one front wheel moves around in random directions, steering the two rear wheels to be moving around in same (random) directions; two more critical points: 1. Round Base Disk can move AI Dog adequately fast (faster than iRobot Roomba), thereby ably inducing and stimulating the dog to be chasing and playing with AI Dog (otherwise—unably, since the dog would not be interested in doing so just because it moves too slowly); 2. Round Base Disk can prevent AI Dog/Dog Statue from falling down when it is chased and thrusted by the dog (otherwise it would fall, because it will be thrusted by the dog to lose balance and fall when the dog is chasing and playing with it)} loaded with a lifelike Dog Statue on it, and, Voices/Sounds Controlling Module starting automatically this series of actions as below—
Round Base Disk (that is AI Dog; Dog Statue on the Disk) is moving around fast in random directions and AI Dog is moving its head, feet/body and tail etc accordingly (these two actions imitate a dog's behaviour); Beeping Pads are glittering (by the LED lights therein), thereby being most ably inducing the dog to jump or step on the Pad(s)); playing the pre-recorded—first barking (or making other dog's vocal sounds like growls or howls—imitates a dog's vocal sounds) for 3 seconds, then beeping continuously for 5 seconds, thereafter stopping beeping for 2 seconds, finally beeping continuously for 5 seconds.

manages to induce and stimulate the dog to chase and play with AI Dog, which (case 1) is still moving around fast in random directions, or, (case 2) has just stopped moving {This means, only after AI Dog has been running as mentioned above for 15 seconds [This is running cycle of AI Dog, including the playing of pre-recorded barks (or other dog's vocal sounds) for 3 seconds plus the beeping for total 10 seconds in first and last times; after 15 seconds there is no sound], does the dog start to chase and play with AI Dog—is different from case 1}.

It also through Beeping Pads [located at the undersides of and surrounding AI Dog Statue in all 4 directions (east, west, south, north) throughout Round Base Disk, quantity 4 or more; one critical point: they must be of flat surfaces (possibly integrated with the surface of Round Base Disk), not arched at all, because even if Pads are the least arched (their surfaces material should be semi-transparent rubber, so that the LEDs inside Beeping Pads can glitter nicely through their surfaces; but they can't glitter as nicely through the surfaces of different material like hard plastic), the dog will be able to bite and grip into the arched surface, thereby lifting up and throwing around the whole AI Dog]—every time when the dog is induced and stimulated to chase AI Dog and jump or step on Round Base Disk, Beeping Pads will be stepped on by the dog and easily beep twice (e.g. through Vibration/Shock Sensor underneath the surfaces of Pads by playing the pre-recorded “beep beep”) [in case 2 these sounds (beeps) will through Voices/Sounds Controlling Module start instantly (takes half second) the series of actions as mentioned above, including Round Base Disk (that is AI Dog) moving around fast in random directions; compared to and different from the pre-recorded initial beeping],

manages to (case 1) further induce and stimulate the dog to be chasing and playing with AI Dog, which is still moving around fast in random directions;

(case 2) induce and stimulate the dog to be chasing and playing with AI Dog, which has just been started (half second before) to be moving around fast in random directions by Voices/Sounds Controlling Module.

Every time after every 15 seconds, if there are any sounds in home and surroundings, the series of actions as mentioned above will repeat, possibly continuously.

AI Dog advanced model has more AIs, to give some examples, it can, chase the dog in return of being chased by the dog,—unlike its basic model which can only be chased by the dog but not the other way around; throw out a (rubber) ball for the dog to fetch it; allow dog owner, through Voices/Sounds Controlling Module to interact easily using Voice Commands for convenience of no need to i.e. grab his or her smartphone for Voice Commands counterparts—Verbal Commands or to grab and throw out the ball with his or her hand for playing fetch, with the dog at home when he or she is or isn't home, as long as Voice Commands are vocalized either by an at-home dog owner directly or by a not-at-home dog owner through an electronic device like an IP Camera with two way audio or a speakerphone etc, or, through smartphone (iOS or android) plus App plus WIFI (connection at home) when he or she is home; plus Internet (connection on the smartphone) when he or she is outside of home (exception: or at home but outside of WIFI range) to interact using Verbal Commands to avoid the noise disturbance of Voice Commands, with the dog at home. (see claim 3 for scenarios of using different Voice Commands and details)
These two pages 5 & 6 as below are added as requested by USPTO to explain the drawing FIG. 5/Appendix:
Dog Statue ((1), as in FIG. 1)'s Mouth Compartment 3-1 contains Fixating Plate 3-11 representing a dog's upper palate and Moving Plate 3-12, inside Dog Statue (1) is there a Catapulting Unit 15, including Base Plate 15-1 and Guidance Chute 15-2, the lower end of Guidance Chute 15-2 joins the upper end of Base Plate 154, the upper end of Guidance Chute 15-2 joins at inside of Mouth Compartment 3-1, Guidance Chute 15-2 slopes, clearance of Guidance Chute 15-2 towards Base Plate 15-1 is less than clearance of Guidance Chute 15-2 towards Mouth Compartment 3-1, Guidance Chute 15-2 includes parallel Upper Pressure Plate 15-21 and Lower Pressure Plate 15-22, the lower end of Upper Pressure Plate 15-21 securely joins the upper end of Base Plate 15-1, the other (upper) end of Upper Pressure Plate 15-21 joins Fixating Plate 3-11, the lower end of Lower Pressure Plate 15-22 is hinge jointed with the upper end of Base Plate 15-1, the upper end of Lower Pressure Plate 15-22 joins Moving Plate 3-12, towards the angle between the bottom of Lower Pressure Plate 15-22 and the top of Base Plate 15-1 is there First Spring 15-3, on top of First Spring 15-3 is Iron Piece 15-31, under First Spring 15-3 is Electromagnet 15-32, which connects to Processor 7, in Guidance Chute 15-2 is Thrusting Lever 15-4, which is between Upper Pressure Plate 15-21 and Lower Pressure Plate 15-22, the lower end of Thrusting Lever 15-4 joins the top of Base Plate 15-1 via Second Spring 15-5, the upper end of Thrusting Lever 15-4 extends to the inside of Mouth Compartment 3-1, Thrusting Lever 15-4 moves on the bottom of Upper Pressure Plate 15-21, between Thrusting Lever 15-4 and Lower Pressure Plate 15-22 are First Latch 15-6 and Second Latch 15-7 engaging First Latch 15-6, inside Mouth Compartment is Shot Ball 15-8.
In the embodiment, when Voices/Sounds Controlling Module “hears” a Voice Command “throw ball”, and feeds the signal to Processor 7, Processor 7 controls how Electromagnet 15-32 works, Electromagnet 15-32 generates power of pulling down Iron Piece 15-31 connected to the bottom of Lower Pressure Plate 15-22, causing—that Lower Pressure Plate moves down pivoting on Hinge Joint, and that Guidance Chute 15-2 expands towards Mouth Compartment 3-1, and that First Latch 15-6 and Second Latch 15-7 engaging First Latch 15-6 disengage, Thrusting Lever 15-4 in Guidance Chute 15-2 is propelled by Second Spring 15-5 and strikes Shot Ball 15-8 throwing it out of the mouth of Dog Statue (1), Electromagnet 15-32 loses electric current in a moment, First Spring 15-3 in between Electromagnet 15-32 and Iron Piece 15-31 separates both of them anew, Lower Pressure Plate 15-22 moves back up and returns to the original position.

Note: This is just an embodiment of one of technical schemes, there may be another alternative and/or supplementary technical scheme to be used for “Throw Balls” Apparatus.

### Advantageous Effects of Invention

The benefits of this utility patent are: AI Dog imitates a dog's behaviour [additionally it can do “up” (stand straight up), “down” (lie down on its belly), etc—all these actions on the advanced model (see claim 3 for details)] and vocal sounds, and beeps, simultaneously Beeping Pads (LEDs inside them) are glittering, in inducing and stimulating the dog to be chasing and playing with it (emphasize: only AI Dog advanced model can make it that both AI Dog and the dog are chasing and playing with each other), and the dog will step on Beeping Pad(s) for it to beep, AI Dog can be running continuously (emphasize: running cycle is 15 seconds), endless fun, so that the dog alone at home won't anymore be bored and sleep all day long; instead the dog will be accompanied by AI Dog as play partner, chasing and playing together, so as to stay healthy,—this is every dog owner's desire.

And AI Dog advanced model can allow dog owner, through Voices/Sounds Controlling Module to interact easily using Voice Commands for convenience of no need to i.e. grab his or her smartphone for Voice Commands counterparts—Verbal Commands or to grab and throw out the ball with his or her hand for playing fetch, with the dog at home when he or she is or isn't home, as long as Voice Commands are vocalized either by an at-home dog owner directly or by a not-at-home dog owner through an electronic device like an IP Camera with two way audio or a speakerphone etc, or, through smartphone (iOS or android) plus App plus WIFI (connection at home) when he or she is home; plus Internet (connection on the smartphone) when he or she is outside of home (exception: or at home but outside of WIFI range) to interact using Verbal Commands to avoid the noise disturbance of Voice Commands, with the dog at home. (see claim 3 for scenarios of using different Voice Commands and details)

Below it is to elaborate further on this utility patent along with Make-Up/Design Diagram and Description of Embodiment.

### BRIEF DESCRIPTIONS OF DRAWINGS/DIAGRAMS

1. FIG. 1—Side View of AI Dog—Make-Up/Design Diagram as below

1. Dog Statue (patent protected), 2. head, 3. feet/body, 4. tail, 5. Round Base Disk (patent protected), 6. Beeping Pads (patent protected; possibly integrated with surface of Round Base Disk), 7/f. one (or two) wheel(s) (towards the head (2)), 7/r. two wheels (towards the tail (4)), 8. Voices/Sounds Controlling Module, 9. Pre-recorded dog's vocal sounds and beeping (initially) and two beeps (secondly when Beeping Pads are pressed by dog's paws), 10. Collision Avoidance module (through e.g. Infrared Sensor), 11. Throw Balls function, 12. batteries compartment, 13. Timer (unit powered on 45 min. while off 30 min. alternately)/Power On or Off, 14. Moving Object Tracking and/or Target (dog) Recognition, or, Auto Follow, technologies. *The advanced model's additional functions: 15. IP Camera, 16. WIFI (module), 17. Voice Commands/Sounds.

FIG. 2—a conventional but patented dog's toy K9 Cruiser demonstrating “Background Art” on page 1

FIG. 3—Top of iRobot Roomba

FIG. 4—Bottom of iRobot Roomba

FIG. 5/Appendix—Side View of “Throw Balls” Apparatus

FIG. 6—Top View of AI Dog

FIG. 7—Rear View of AI Dog

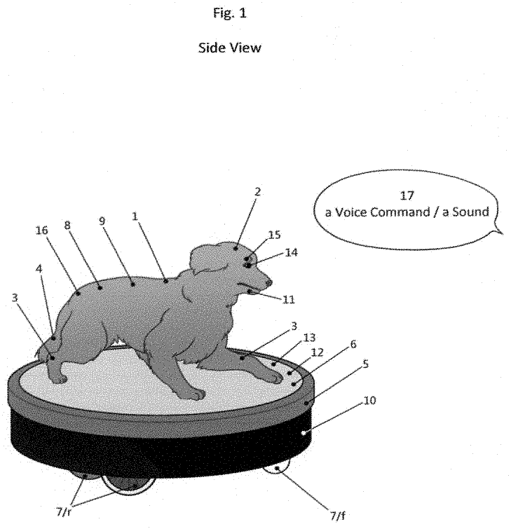

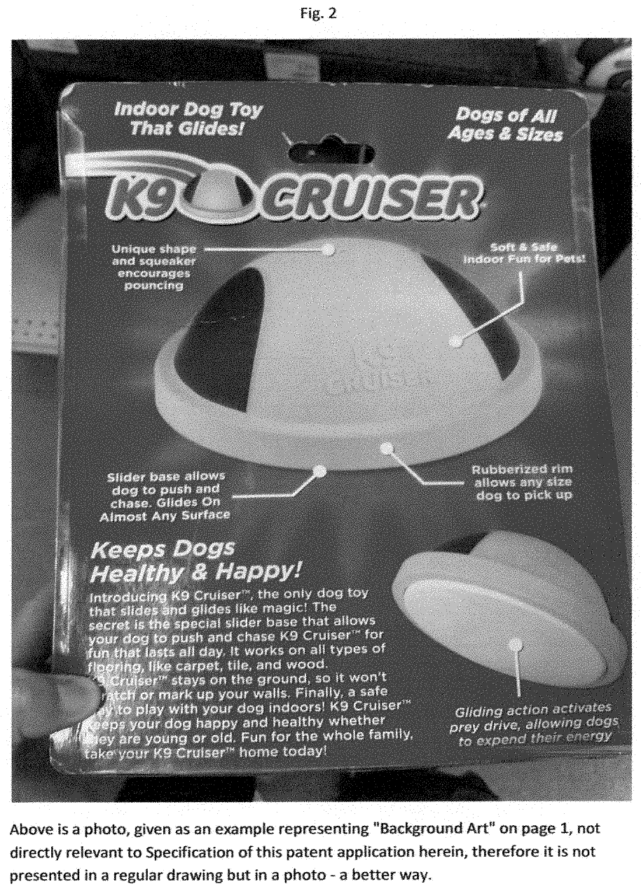

### DESCRIPTION OF EMBODIMENT

First, any sounds in home or surroundings, for example, once the dog alone at home starts moving and making sounds of steps, the sounds will automatically start at the same time,—Round Base Disk/AI Dog is moving around fast in random directions; its head and feet/body and tail etc are moving accordingly, Beeping Pads (LEDs inside them) are glittering; playing the pre-recorded: first barking (or other dog's vocal sounds) for 3 seconds, beeping continuously for 5 seconds, stopping beeping for 2 seconds, at last beeping (again) continuously for 5 seconds. This series of actions will induce and stimulate the dog to be chasing and playing with AI Dog, (case 1) which is still moving around fast in random directions, or, (case 2) which has just stopped moving. Moreover, when the dog jumps or steps on Round Base Disk and the underside of Dog Statue, the paws will step on one or more of Beeping Pads, thereby making them beep, which (case 1) further induces and stimulates the dog to be chasing and playing with AI Dog, (case 1) which is still moving around fast in random directions, or, (case 2) which has just been started to be moving around fast in random directions by the beeps just made from Beeping Pad(s).

After every 15 seconds pass by, if there are any sounds in home or surroundings, the series of actions as mentioned above will repeat one more time, possibly continuously, in this way the dog alone at home would still be able to keep active and healthy, chasing and playing with AI Dog.

AI Dog advanced model can also, chase the dog in return of the dog chasing it (namely “chase each other”), throw balls, etc. (see claim 3 for details)

1. A kind of dog's play partner AI Dog, its features are: Voices/Sounds Controlling Module (8) once “hears” any sounds (17), it will automatically start,—Round Base Disk (5) loaded with Dog Statue (1) on it is moving around fast in random directions, Dog Statue (1)'s head (2), feet/body (3) and tail (4) etc are moving accordingly, Beeping Pads (6) (possibly integrated with surface of Round Base Disk (5); 4 or more Pads) are glittering, playing the pre-recorded dog's vocal sounds and beeps, this series of actions will induce and stimulate the dog to be chasing and playing with AI Dog, (case 1) which is still moving around fast in random directions, or, (case 2) which has just stopped moving. Moreover, when the dog jumps or steps on Round Base Disk (5) and the underside of Dog Statue (1), the paws will step on one or more of Beeping Pads (6) [one critical point: Pads' surfaces must be flat, not arched at all, because even if they are the least arched (Pads' surfaces material should be semi-transparent rubber, so that the LEDs inside Beeping Pads (6) can glitter nicely through the surfaces; but they can't glitter as nicely through the surfaces of different material like hard plastic), the dog will be able to bite and grip into the arched surface, thereby lifting up and throwing around the whole AI Dog], thereby making them beep ((one or) two beeps or more), which (case 1) further induces and stimulates the dog to be chasing and playing with AI Dog, (case 1) which is still moving around fast in random directions, or, (case 2) which has just been started to be moving around fast in random directions by the beeps just made from Beeping Pad(s) (6). The beeps (one or more beeps) as mentioned herein and all other kinds of sounds like “boom boom” etc; Dog Statue (1) and other (animal) statues; any number of Beeping Pads (6), will all fall under protection of the patent herein.

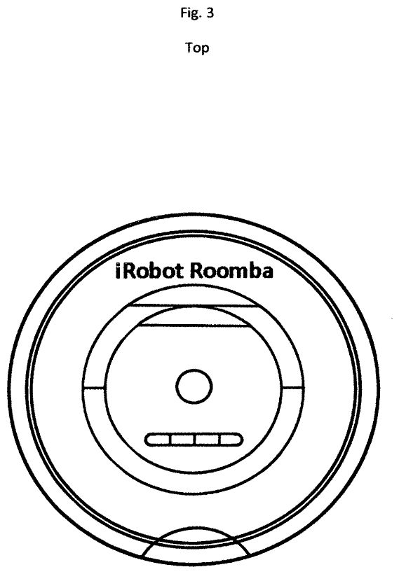

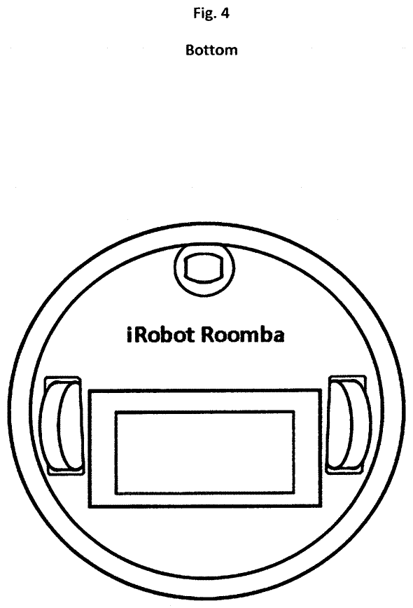

2. Based on claim 1, AI Dog's features are: underneath Round Base Disk (5) are there three (or 4) wheels, on one (front) end (towards Dog Statue (1)'s head) there is one (or two) wheels (7/f) moving around in random directions, which is steering the two wheels (7/r) on the other (rear) end (towards Dog Statue (1)'s rear) to move around in same random directions; when the battery power of driving the two wheels on rear end runs out, Round Base Disk can still be moved around by the dog,—working the same way as iRobot Roomba's round disk, see FIGS. 3 & 4; AI Dog has four modes: 1. Timer (13) (powered on with timer for 45 minutes, off for 30 minutes), 2. ON/OFF, 3. Be able to adjust the volume of playing of the pre-recorded barks (or other dog's vocal sounds), (firstly) beeping, and (secondly) beeps (started by e.g. a Vibration/Shock Sensor underneath (or embedded in) the surface of Beeping Pad (6)); (Round) Base Disk (5) of all different diameters from the one as mentioned herein (about 1 foot) and of non-round will all fall under protection of the patent herein.

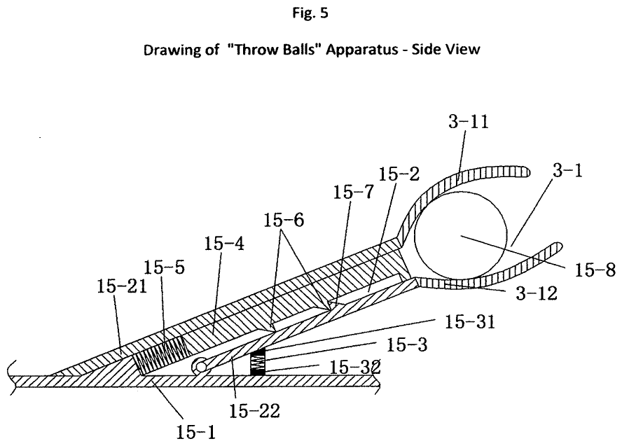

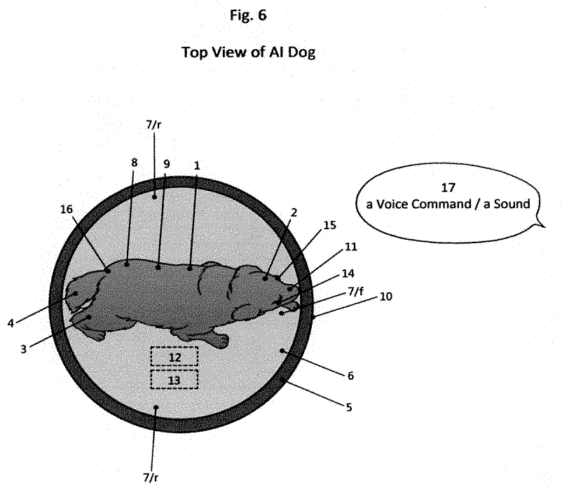

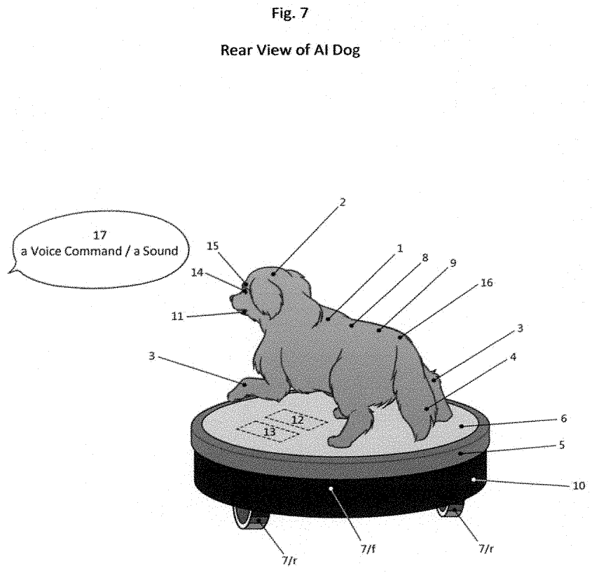

3. Based on claim 2, AI Dog's advanced features are: the advanced model's front wheel (7/f)'s moving directions can be not only random (Auto-Play Mode), but also target-driven (Automatic or Manual Mode)—hence AI Dog can chase (or approach) the dog as below.
(1) In Automatic Mode:
Auto Follow technology, or, Moving Object Tracking and/or Target Recognition technologies will automatically steer the front wheel (7/f) to guide AI Dog to chase (or approach) the dog;
Note: In this mode, in case AI Dog moves to only 30 cm away from any obstacle, the front wheel (7/f) will automatically stop (namely “Collision Avoidance” (module) (10)) and then move in random directions (left, right, backwards, forward) just like the basic model in Auto-Play Mode, at the same time the aforementioned technologies continue to guide AI Dog to chase (or approach) the dog.
In Auto-Play Mode:
AI Dog basic model moves around in random directions playing with the dog at home.
(2) In Manual Mode:
Referring to on page 4/5 “AI Dog advanced model can allow dog owner, through Voices/Sounds Controlling Module to interact easily using Voice Commands for convenience of no need to i.e. grab his or her smartphone for Voice Commands counterparts—Verbal Commands or to grab and throw out the ball with his or her hand for playing fetch, with the dog at home when he or she is or isn't home, as long as Voice Commands are vocalized either by an at-home dog owner directly or by a not-at-home dog owner through an electronic device like an IP Camera with two way audio or a speakerphone etc, or, through smartphone (iOS or android) plus App plus WIFI (connection at home) when he or she is home; plus Internet (connection on the smartphone) when he or she is outside of home (exception: or at home but outside of WIFI range) to interact using Verbal Commands to avoid the noise disturbance of Voice Commands, with the dog at home (see claim 3 for scenarios of using different Voice Commands and details)”,
dog owner can use either Voice Commands or Verbal Commands (regardless of he or she is home as explained on page 4/5, although Voice Commands are usually preferred to their counterparts—Verbal Commands when he or she is home) to manually steer the front wheel (7/f) to guide AI Dog to chase (or approach) the dog.
Note: In this mode, in case AI Dog moves to only 30 cm away from any obstacle, the front wheel (7/f) will automatically stop (namely “Collision Avoidance” (module) (10)) and then dog owner will keep using Voice Commands or Verbal Commands to continue to guide AI Dog to chase (or approach) the dog.
The advanced model also has a function of “throw balls” (11) to induce the dog to chase and fetch the ball, in this way the dog alone at home will still keep active and healthy.
The advanced model's Voices/Sounds Controlling Module can follow all kinds of Voice Commands (17) for AI Dog to execute. For example, dog owner speaks a Voice Command (17) “throw ball” (11), AI Dog will throw out a ball through the Apparatus as illustrated in Appendix/FIG. 5 for the dog to chase and fetch it; speaks a Voice Command (17) “shoot picture (or video)”, AI Dog will automatically approach the dog (as explained above) for IP camera (15) to shoot pictures or videos (pictures or videos will be through emails or the cloud able to be looked at real time by dog owner on his or her smartphone).
And there are other Voice Commands (17). To give some examples, Voice Commands can instruct AI Dog to “go forward, left, right, backwards” etc, or, to imitate a dog's behaviour like “down” and “up” etc and a dog's vocal sounds.
All Voice Commands like “throw ball” and “shoot picture (or video)”, etc, can be also executed by AI Dog as their counterparts—Verbal Commands, through smartphone (iOS or android) plus App plus WIFI when dog owner is home; plus Internet when dog owner is outside of home (exception: or at home, but outside of WIFI range).
